(19) United States
(12) Patent Application Publication
(10) Pub. No.: US 2008/0007158 A1
(43) Pub. Date: Jan. 10, 2008

(54) Linear Polysiloxanes, Silicone Composition, and Organic Light-Emitting Diode

(76) Inventors: Omar Farooq, Saginaw, MI (US); Shihe Xu, Midland, MI (US); Paul Schalk, Bay City, MI (US); Toshio Suzuki, Lexington, MA (US)

Correspondence Address: DOW CORNING CORPORATION CO1232, 2200 W. SALZBURG ROAD, P.O. BOX 994, MIDLAND, MI, 48686-0994, US

(21) Appl. No.: 11/597,979

(22) PCT Filed: Apr. 8, 2005
(86) PCT No.: PCT/US05/12104

§ 371 Date: Aug. 16, 2007

Related U.S. Application Data
(60) Provisional application No. 60/579,640, filed on Jun. 15, 2004.

(51) Int. Cl. C08G 77/388; H01J 1/63

(52) U.S. Cl. 313/504; 528/33

(57) ABSTRACT

Linear polysiloxanes and more particularly to linear polysiloxanes containing N-carbazolylalkyl groups and (diarylamino)phenyl groups. The present invention also relates to a silicone composition containing a linear polysiloxane and an organic light-emitting diode (OLED) containing a linear polysiloxane or a cured polysiloxane.

### CROSS-REFERENCE TO RELATED APPLICATIONS

None

### FIELD OF THE INVENTION

The present invention relates to linear polysiloxanes and more particularly to linear polysiloxanes containing N-carbazolylalkyl groups and (diarylamino)phenyl groups. The present invention also relates to a silicone composition containing a linear polysiloxane and an organic light-emitting diode (OLED) containing a linear polysiloxane or a cured polysiloxane.

### BACKGROUND OF THE INVENTION

Linear polysiloxanes containing carbazolylalkyl groups or (diphenylamino)phenyl groups are known in the art. For example, Strohriegl (Makromol. Chem., Rapid Commun., 1986, 7, 771-775) describes the preparation and characterization of a series of polysiloxanes with pendant carbazole groups, wherein the carbazole units are separated from the siloxane backbone by alkylene spacers.

U.S. Pat. No. 4,933,053 to Tieke discloses electrically conductive polymers obtainable by anodic oxidation of starting polymers consisting of 5-100 mol % of recurring structural units of the formula I and 95-0 mol % of recurring structural units of the formula II 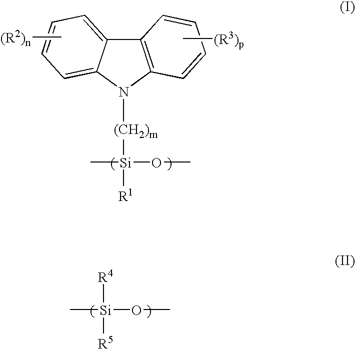
in which R¹ and R⁴ independently of one another are C₁-C₄ alkyl, C₁-C₄ alkoxy, phenyl or phenoxy, R² and R³ independently of one another are C₁-C₄ alkyl, C₁-C₄ alkoxy, halogen, cyano or nitro, R⁵ is C₁-C₁₈ alkyl, which is unsubstituted or can be substituted by one or two hydroxyl groups, or is phenyl or hydroxyl, m is an integer from 3-11, and n and p independently of one another are integers from 0 to 2. The '053 patent teaches the products are suitable especially as electrochromic display elements, as a positive electrode material or as electrically conductive films.

Derwent Abstract No. 1987-158535 of European Patent Application No. EP 0224784 to Leyrer et al. discloses polysiloxanes having lateral carbazole groups attached to the main polymer chain. The Abstract teaches the polysiloxanes can be used in electrophotographic recording materials and for providing electrophotographic offset printing plates.

The Patent Abstracts of Japan publication corresponding to Japanese Patent Application No. 02127432 to Kazumasa et al. discloses a carbazole group-containing curable composition containing (A) a carbazole group-containing curable compound having a carbazole group, OH group bonded to silicon atom or hydrolysable group and silicon atom-containing group crosslinkable by forming a siloxane bond and (B) a silanol condensation catalyst.

Linear polysiloxanes containing (diphenylamino)phenyl groups are also known in the art. For example, Belfield et al. (Polym. Prep. 1998, 39(20), 445-446) describes the synthesis of polysiloxanes containing triphenylamine moieties or carbazole moieties.

Although, the aforementioned references disclose linear polysiloxanes containing either carbazolylalkyl groups or (diphenylamino)phenyl groups, they do not teach the linear polysiloxanes of the present invention containing both carbazolylalkyl groups and (diarylamino)phenyl groups.

### SUMMARY OF THE INVENTION

The present invention is directed to a first linear polysiloxane comprising from 1 to 99 mol % of units having the formula I, from 1 to 20 mol % of units having the formula II, 1 to 99 mol % of units having formula III, and units having the formula IV: 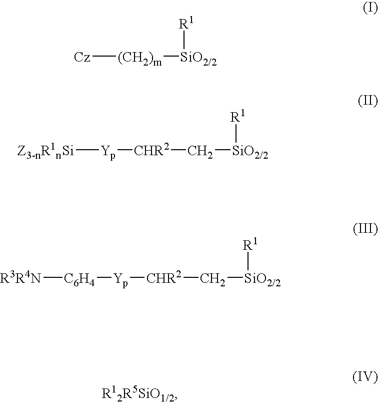
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; each R⁵ is independently R¹, —H, —(CH₂)ₘ-Cz, —CH₂—CHR²—Yₚ—SiR¹ₙZ₃₋ₙ, or —CH₂—CHR²—Yₚ—C₆H₄—NR⁴R³, Cz is N-carbazolyl; Y is a divalent organic group; Z is a hydrolysable group; m is an integer from 2 to 10; n is 0, 1, or 2; and p is 0 or 1.

The present invention is also directed to a second linear polysiloxane comprising from 1 to 99 mol % of units having the formula I, from 1 to 99 mol % of units having the formula III, and units having the formula V: 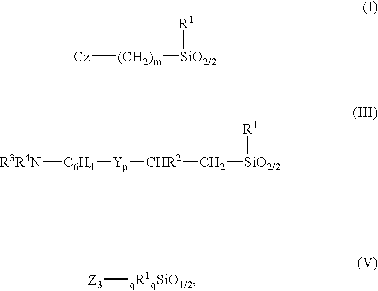
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; Cz is N-carbazolyl; Y is a divalent organic group; Z is a hydrolysable group; m is an integer from 2 to 10; p is 0 or 1; and q is 0, 1, or 2.

The present invention is also directed to a third linear polysiloxane comprising from 1 to 99 mol % of units having the formula I, from 1 to 99 mol % of units having the formula III, and units having the formula VI: 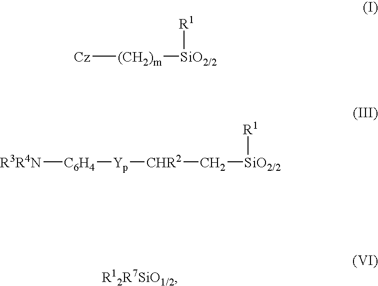
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; Cz is N-carbazolyl; each R⁷ is independently R¹, —H, —(CH₂)ₘ-Cz, or —CH₂—CHR²—Yₚ—C₆H₄—NPh₂, Cz is N-carbazolyl; Y is a divalent organic group; m is an integer from 2 to 10; and p is 0 or 1.

The present invention is also directed to a silicone composition comprising a polysiloxane selected from the first and second linear polysiloxanes, a condensation catalyst, and an organic solvent.

The present invention is further directed to an organic light-emitting diode comprising:

a substrate having a first opposing surface and a second opposing surface;

a first electrode layer overlying the first opposing surface;

a light-emitting element overlying the first electrode layer, the light emitting element comprising
a hole-transport layer and
an emissive/electron-transport layer, wherein the hole-transport layer and the emissive/electron transport layer lie directly on one another, and the hole-transport layer comprises a cured polysiloxane prepared by applying the aforementioned silicone composition to form a film and curing the film; and

a second electrode layer overlying the light-emitting element.

The present invention is still further directed to an organic light-emitting diode comprising:

a substrate having a first opposing surface and a second opposing surface;

a first electrode layer overlying the first opposing surface;

a light-emitting element overlying the first electrode layer, the light emitting element comprising
a hole-transport layer and
an emissive/electron-transport layer, wherein the hole-transport layer and the emissive/electron transport layer lie directly on one another, and the hole-transport layer comprises the third linear polysiloxane; and

a second electrode layer overlying the light-emitting element.

The linear polysiloxanes of the present invention exhibit electroluminescence, emitting light when subjected to an applied voltage. Moreover, the linear polysiloxanes containing hydrolysable groups can be cured to produce durable cross-linked polysiloxanes. Also, the linear polysiloxanes can be doped with small amounts of fluorescent dyes to enhance the electroluminescent efficiency and control the color output of the cured polysiloxane.

The silicone composition of the present invention can be conveniently formulated as a one-part composition. Moreover, the silicone composition has good shelf-stability in the absence of moisture. Importantly, the composition can be applied to a substrate by conventional high-speed methods such as spin coating, printing, and spraying. Also, the silicone composition can be readily cured by exposure to moisture at mild to moderate temperatures.

The cured polysiloxane of the present invention exhibits electroluminescence. Moreover, the cured polysiloxane has good primerless adhesion to a variety of substrates. The cured polysiloxane also exhibits excellent durability, chemical resistance, and flexibility at low temperatures. Additionally, the cured polysiloxane exhibits high transparency, typically at least 95% transmittance at a thickness of 100 nm, in the visible region of the electromagnetic spectrum. Importantly, the polysiloxane is substantially free of acidic or basic components, which are detrimental to the electrode and light-emitting layers in OLED devices.

The OLED of the present invention exhibits good resistance to abrasion, organic solvents, moisture, and oxygen. Moreover, the OLED exhibits high quantum efficiency, low turn-on voltage, and photostability.

The OLED is useful as a discrete light-emitting device or as the active element of light-emitting arrays or displays, such as flat panel displays. OLED displays are useful in a number of devices, including watches, telephones, lap-top computers, pagers, cellular phones, digital video cameras, DVD players, and calculators.

These and other features, aspects, and advantages of the present invention will become better understood with reference to the following description, appended claims, and accompanying drawing.

### BRIEF DESCRIPTION OF THE DRAWINGS

FIG. 1 shows a cross-sectional view of a first embodiment of an OLED according to the present invention.

FIG. 2 shows a cross-sectional view of a second embodiment of an OLED according to the present invention.

### DETAILED DESCRIPTION OF THE INVENTION

As used herein, the term “linear polysiloxane” refers to a polysiloxane comprising an average of at least 90 mol %, alternatively at least 95 mol %, alternatively at least 98 mol %, of difunctional siloxane units (i.e., D units) per molecule. Also, the “mol %” of siloxane units is defined as the ratio of the number of moles of the siloxane units to the total number of moles of siloxane units in the polysiloxane, multiplied by 100. Further, the term “hydrocarbyl group free of aliphatic unsaturation” means the group is free of aliphatic carbon-carbon double bonds and aliphatic carbon-carbon triple bonds. Still further, the terms “N-carbazolyl,” “10(9H)-acridinyl,” and “10,11-dihydro-5H-dibenz[b,f]azepin-5-yl” refer to groups having the following formulae: 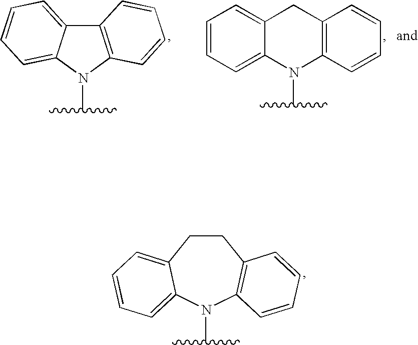
respectively.

A first linear polysiloxane according to the present invention comprises from 1 to 99 mol % of units having the formula I, from 1 to 20 mol % of units having the formula II, 1 to 99 mol % of units having formula III, and units having the formula IV: 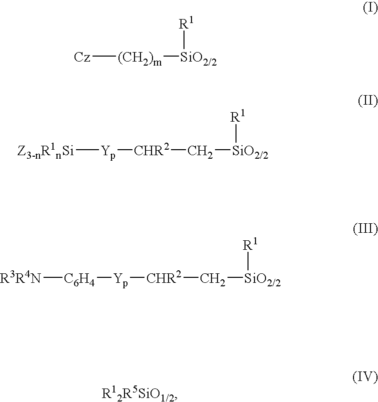
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; each R⁵ is independently R¹, —H, —(CH₂)ₘ-Cz, —CH₂—CHR²—Yₚ—SiR¹ₙZ₃₋ₙ, or —CH₂—CHR²—Yₚ—C₆H₄—NR⁴R³, Cz is N-carbazolyl; Y is a divalent organic group; Z is a hydrolysable group; m is an integer from 2 to 10; n is 0, 1, or 2; and p is 0 or 1. Alternatively, the subscript m has a value of from 3 to 10, or from 3 to 6.

The hydrocarbyl groups represented by R¹, R², and R⁵ are free of aliphatic unsaturation and typically have from 1 to 10 carbon atoms, alternatively from 1 to 6 carbon atoms. Acyclic hydrocarbyl groups containing at least 3 carbon atoms can have a branched or unbranched structure. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, decyl, undecyl, dodecyl, tridecyl, tetradecyl, pentadecyl, hexadecyl, heptadecyl, and octadecyl; cycloalkyl, such as cyclopentyl, cyclohexyl, and methylcyclohexyl; aryl, such as phenyl and naphthyl; alkaryl, such as tolyl and xylyl; and aralkyl, such as benzyl and phenethyl.

The aryl groups represented by R³ and R⁴ typically have from 6 to 18 carbon atoms, alternatively from 6 to 12 carbon atoms. The aryl groups represented by R³ and R⁴ may be the same or different. Examples of aryl groups include, but are not limited to phenyl, naphthyl, acenaphthyl, anthracenyl, azulenyl, fluorenyl, indacenyl, indenyl, perylenyl, phenalenyl, and phenanthrenyl.

The divalent organic groups represented by Y typically have from 1 to 18 carbon atoms, alternatively from 1 to 10 carbon atoms, alternatively from 1 to 6 carbon atoms. In addition to carbon and hydrogen, the divalent organic groups may contain other atoms such as nitrogen, oxygen, and halogen, provided the divalent group does not inhibit the hydrosilylation reaction, described below, used to prepare the polysiloxane or react with the hydrolysable group Z in the polysiloxane. Examples of divalent organic groups represented by Y include, but are not limited to, hydrocarbylene such as methylene, ethylene, propane-1,3-diyl, 2-methylpropane-1,3-diyl, butane-1,4-diyl, butane-1,3-diyl, pentane-1,5,-diyl, pentane-1,4-diyl, hexane-1,6-diyl, octane-1,8-diyl, decane-1,10-diyl, cyclohexane-1,4-diyl, and phenylene; halogen-substituted hydrocarbylene such as chloroethylene and fluoroethylene; alkyleneoxyalkylene such as —CH₂OCH₂CH₂CH₂—, —CH₂CH₂OCH₂CH₂—, —CH₂CH₂OCH(CH₃)CH₂—, and —CH₂OCH₂CH₂OCH₂CH₂—; —O—; oxyalkylene such as —OCH₂CH₂—, —OCH₂CH₂CH₂—, and —OCH₂CH(CH₃)CH₂—; and carbonyloxyalkylene, such as —C(═O)O—(CH₂)₃—.

As used herein, the term “hydrolysable group” means the silicon-bonded group Z can react with water to form a silicon-bonded —OH (silanol) group. Examples of hydrolysable groups represented by Z include, but are not limited to, —Cl, Br, —OR⁶, —OCH₂CH₂OR⁶, CH₃C(═O)O—, Et(Me)C═N—O—, CH₃C(═O)N(CH₃)—, and —ONH₂, wherein R⁶ is C₁ to C₈ hydrocarbyl or halogen-substituted hydrocarbyl, both free of aliphatic unsaturation.

Examples of hydrocarbyl groups represented by R⁶ include, but are not limited to, unbranched and branched alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, and octyl; cycloalkyl, such as cyclopentyl, cyclohexyl, and methylcyclohexyl; phenyl; alkaryl, such as tolyl and xylyl; and aralkyl, such as benzyl and phenethyl. Examples of halogen-substituted hydrocarbyl groups include, but are not limited to, 3,3,3-trifluoropropyl, 3-chloropropyl, chlorophenyl, and dichlorophenyl.

In the units having formula III, 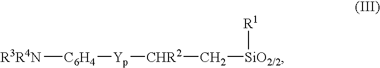
the phenylene group having the formula —C₆H₄— can be ortho-, meta-, or para-phenylene.

The first linear polysiloxane is a copolymer comprising units having formulae I, II, III, and IV, above. The polysiloxane typically contains from 1 to 99 mol %, alternatively from 5 to 90 mol %, alternatively from 50 to 90 mol %, of units having formula I; from 1 to 20 mol %, alternatively from 1 to 10 mol %, alternatively from 5 to 10 mol %, of units having formula II; and from 1 to 99 mol %, alternatively from 5 to 75 mol %, alternatively from 5 to 50 mol %, of units having formula III. In addition to units having formulae I, II, III, and IV, the first linear polysiloxane may contain up to 30 mol %, alternatively up to 10 mol %, alternatively up to 5 mol %, of other siloxane units. Examples of other siloxane units include, but are not limited to, units having the following formulae: R¹HSiO_{2/2}, R¹₂HSiO_{1/2}, and R¹₂SiO_{2/2}, wherein R¹ is as defined and exemplified above.

The first linear polysiloxane typically has a number-average molecular weight of from 1,000 to 1,000,000, alternatively from 2,500 to 150,000, alternatively from 10,000 to 30,000, where the molecular weight is determined by gel permeation chromatography employing a low angle laser light scattering detector.

Examples of the first linear polysiloxane include, but are not limited to, polysiloxanes having the following formulae: [Cz(CH₂)₃Si(Me)O_{2/2}]_{0.70}[(AcO)₃Si(CH₂)₂Si(Me)O_{2/2}]_{0.08}[HSi(Me)O_{2/2}]_{0.12}[Ph₂NC₆H₄(CH₂)₃Si(Me)O_{2/2}]_{0.09}[Me₃SiO_{1/2}]_{0.01}, [Cz(CH₂)₃Si(Et)O_{2/2}]_{0.70}[(AcO)₂Si(Me)(CH₂)₂Si(Et)O_{2/2}]_{0.1}[HSi(Et)_{2/2}]_{0.1}[Ph₂NC₆H₄(CH₂)₃Si(Me)O_{2/2}]_{0.09}[Me₃SiO_{1/2}]_{0.01}, [Cz(CH₂)₃Si(Me)O_{2/2}]_{0.53}[(MeO)₃Si(CH₂)₃C(O)OCH(Me)CH₂Si(Me)O_{2/2}]_{0.1}[HSi(Me)O_{2/2}]_{0.1}[Ph₂NC₆H₄(CH₂)₃Si(Me)O_{2/2}]_{0.25}[Me₃SiO_{1/2}]_{0.02}, [Cz(CH₂)₅Si(Me)O_{2/2}]_{0.70}[(MeO)₃Si(CH₂)₃Si(Me)O_{2/2}]_{0.1}[HSi(Me)O_{2/2}]_{0.09}[Ph₂NC₆H₄O(CH₂)₂Si(Me)O_{2/2}]_{0.1}[Me₃SiO_{1/2}]_{0.01}, and [Cz(CH₂)₃Si(Me)O_{2/2}]_{0.40}[(MeO)₃Si(CH₂)₃Si(Me)O_{2/2}]_{0.1}[HSi(Me)O_{2/2}]_{0.1}[NAPhNC₆H₄(CH₂)₃Si(Me)O_{2/2}]_{0.39}[Me₃SiO_{1/2}]_{0.01}, wherein Me is methyl, Et is ethyl, Ph is phenyl, NA is naphthyl, Cz is N-carbazolyl, OAc is acetoxy, and the numerical subscripts denote mole fractions. Also, in the preceding formulae, the sequence of the units is unspecified.

The first linear polysiloxane can be prepared by reacting (a) an organohydrogenpolysiloxane having the formula R²R¹₂SiO(R¹HSiO)ₐSiR¹₂R² with (b) an N-alkenyl carbazole having the formula Cz-(CH₂)ₘ₋₂—CH═CH₂, (c) an alkenyl silane having the formula Z₃₋ₙR¹ₙSi—Yₚ—CR²═CH₂, and (d) an alkenyl-functional triarylamine having the formula R³R⁴N—C₆H₄—Yₚ—CR²—CH₂ in the presence of (e) a hydrosilylation catalyst and, optionally, (f) an organic solvent, wherein subscript a has a value such that the organohydrogenpolysiloxane has a number-average molecular weight of from 240 to 220,000; and R¹, R², R³, R⁴, Cz, Y, Z, m, n, and p are as defined and exemplified above for the first linear polysiloxane.

Organohydrogenpolysiloxane (a) has the formula R²R¹₂SiO(R¹HSiO)ₐSiR¹₂R², wherein R¹ and R² are as defined and exemplified above for the first linear polysiloxane, and the subscript a has a value such that the organohydrogenpolysiloxane typically has a number-average molecular weight of from 240 to 220,000, alternatively from 1,000 to 150,000, alternatively from 1,000 to 75,000.

Examples of organohydrogenpolysiloxanes suitable for use as organohydrogenpolysiloxane (a) include, but are not limited to, trimethylsiloxy-terminated poly(methylhydrogensiloxane)s, hydrogendimethylsiloxy-terminated poly(methylhydrogensiloxane)s, triethylsiloxy-terminated poly(methylhydrogensiloxane)s, hydrogendiethylsiloxy-terminated poly(methylhydrogensiloxane)s, trimethylsiloxy-terminated poly(ethylhydrogensiloxane)s, hydrogendimethylsiloxy-terminated poly(ethylhydrogensiloxane)s, triethylsiloxy-terminated poly(ethylhydrogensiloxane)s, hydrogendiethylsiloxy-terminated poly(ethylhydrogensiloxane)s, trimethylsiloxy-terminated poly(phenylhydrogensiloxane)s, hydrogendimethylsiloxy-terminated poly(phenylhydrogensiloxane)s, triethylsiloxy-terminated poly(phenylhydrogensiloxane)s, and hydrogendiethylsiloxy-terminated poly(phenylhydrogensiloxane)s.

Methods of preparing organohydrogenpolysiloxanes, exemplified by the production of poly(methylhydrogen)siloxanes, are well known in the art. For example, poly(methylhydrogen)siloxanes having a degree of polymerization up to about 500 can be prepared by hydrolysis and condensation of the appropriate organohalosilanes, according to U.S. Pat. No. 2,491,843; Poly(methylhydrogen)siloxanes having a number-average molecular weight greater than 10⁵ can be prepared by polymerization of 1,3,5,7-tetramethylcyclotetrasiloxane using trifluoromethanesulfonic acid as the initiator in methylene chloride at ambient temperature, as described by Gupta et al. (Polym. J., 1993, 29 (1), 15-22). Alternatively relatively high molecular weight (Mₙ=7,000-70,000) poly(methylhydrogen)siloxanes can be prepared by polymerization of 1,3,5,7-tetramethylcyclotetrasiloxane in an aqueous emulsion using dodecylbenzenesulfonic acid and Brij 35 [polyoxyethylene(23) lauryl ether] as the emulsifier/initiator and coemulsifier, respectively, as taught by Maisonnier et al. (Polym. Int., 1999, 48, 159-164). Further, linear triorganosiloxy-endcapped poly(methylhydrogen)siloxanes having a degree of polymerization up to about 2200 can be prepared by (i) forming a reaction mixture containing a silanol-free hexaorganodisiloxane, one or more silanol-free methylhydrogen cyclic siloxanes, and less than about 100 parts per million water, (ii) contacting the reaction mixture with anhydrous trifluoromethanesulfonic acid catalyst, and (iii) agitating the mixture and the catalyst at below 100° C. to form a linear triorganosiloxy-endcapped methylhydrogen polysiloxane, as disclosed in U.S. Pat. No. 5,554,708.

N-alkenyl carbazole (b) is at least one N-alkenyl carbazole having the formula Cz-(CH₂)ₘ₋₂—CH═CH₂, wherein Cz and m are as defined and exemplified above for the first linear polysiloxane.

Examples of N-alkenyl carbazoles include, but are not limited to, carbazoles having the following formulae: CH₂═CH-Cz, CH₂═CH—CH₂-Cz, CH₂═CH—(CH₂)₃-Cz, CH₂═CH—(CH₂)₅-Cz, and CH₂═CH—(CH₂)₈-Cz, wherein Cz is N-carbazolyl.

N-alkenyl carbazole (b) can be a single N-alkenyl carbazole or a mixture comprising two or more different N-alkenyl carbazoles, each having the formula Cz-(CH₂)ₘ₋₂—CH═CH₂, wherein Cz and m are as defined and exemplified above for the first linear polysiloxane.

Methods of preparing N-alkenyl carbazoles are well known in the art. For example, the N-alkenyl carbazoles can be prepared by reacting an co-alkenyl bromide having the formula Br—(CH₂)ₘ₋₂—CH═CH₂ with sodium carbazole, as described by Heller et al. (Makromol. Chem., 1964, 73, 48).

Alkenyl silane (c) is at least one alkenyl silane having the formula Z₃₋ₙR¹ₙSi—Yₚ—CR²═CH₂, wherein R¹, R², Y, Z, and n are as defined and exemplified above for the first linear polysiloxane.

Examples of alkenyl silanes include, but are not limited to, silanes having the following formulae: CH₂═C(Me)-C(═O)—OCH₂CH₂CH₂Si(OMe)₃, CH₂═CH—Si(OAc)₃, CH₂═CH—(CH₂)₉—Si(OMe)₃, CH₂═CH—Si(OAc)₂(OMe), and CH₂═CH—CH₂—Si(OMe)₃, where Me is methyl and OAc is acetoxy.

Alkenyl silane (c) can be a single alkenyl silane or a mixture comprising two or more different alkenyl silanes, each having the formula Z₃₋ₙR¹ₙSi—Yₚ—CR²═CH₂, wherein R¹, R², Y, Z, and n are as defined and exemplified above for the first linear polysiloxane.

Methods of preparing alkenyl silanes are well known methods in the art. For example, alkenyl silanes can be prepared by direct syntheses, Grignard reactions, addition of organosilicon hydrides to alkenes or alkynes, condensation of chloroolefins with organosilicon hydrides, and dehydrohalogenation of haloalkylsilanes. These and other methods are described by W. Noll in Chemistry and Technology of Silicones, Academic Press: New York, 1968.

Alkenyl-functional triarylamine (d) is at least one alkenyl-functional triarylamine having the formula R³R⁴N—C₆H₄—Yₚ—CR²═CH₂, wherein R², R³, R⁴, Y, and p are as defined and exemplified above for the first linear polysiloxane.

Examples of alkenyl-functional triarylamines include, but are not limited to, amines having the following formulae:

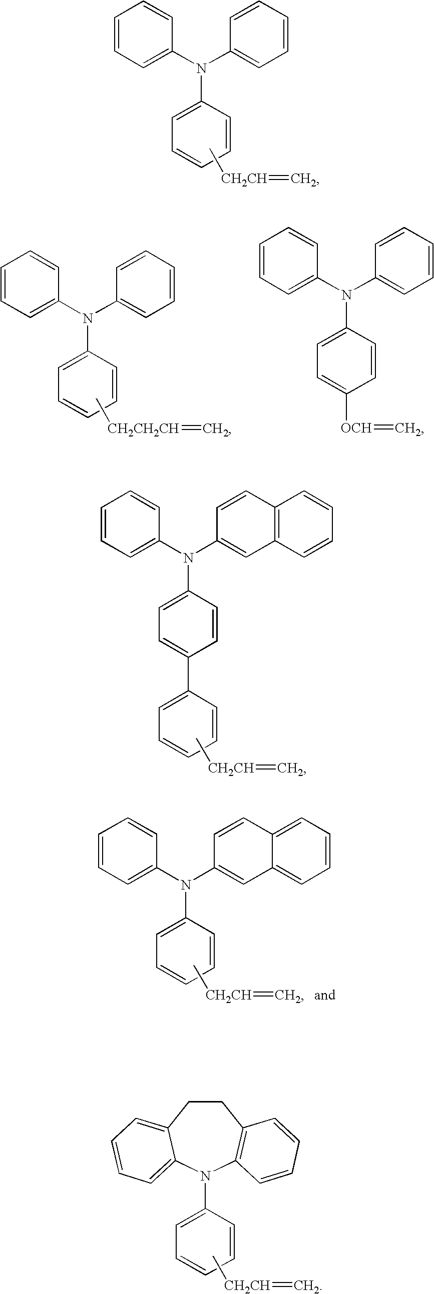

Alkenyl-functional triarylamine (d) can be a single alkenyl-functional triarylamine or a mixture comprising two or more different alkenyl-functional triarylamines, each having the formula R³R⁴N—C₆H₄—Yₚ—CR²═CH₂, wherein R², R³, R⁴, Y, and p are as defined and exemplified above for the first linear polysiloxane.

Methods of preparing alkenyl amines suitable for use as alkenyl-functional triarylamine (d) are well known methods in the art. For example, the alkenyl-functional triarylamines can be prepared by reacting an ω-alkenyl bromide having the formula Br—Yₚ—CR²═CH₂ with a Grignard Reagent having the formula R³R⁴N—C₆H₄MgBr, wherein R², R³, R⁴, Y, and p are as defined and exemplified above for the first linear polysiloxane.

Hydrosilylation catalyst (e) can be any of the well-known hydrosilylation catalysts comprising a platinum group metal (i.e., platinum, rhodium, ruthenium, palladium, osmium and iridium) or a compound containing a platinum group metal. Preferably, the platinum group metal is platinum, based on its high activity in hydrosilylation reactions.

Preferred hydrosilylation catalysts include the complexes of chloroplatinic acid and certain vinyl-containing organosiloxanes disclosed by Willing in U.S. Pat. No. 3,419,593, which is hereby incorporated by reference. A preferred catalyst of this type is the reaction product of chloroplatinic acid and 1,3-diethenyl-1,1,3,3-tetramethyldisiloxane.

Organic solvent (e) is at least one organic solvent. The organic solvent can be any aprotic or dipolar aprotic organic solvent that does not react with organohydrogen-polysiloxane (a), N-alkenyl carbazole (b), alkenyl silane (c), alkenyl-functional triarylamine (d), or the first linear polysiloxane under the conditions of the present method, and is miscible with components (a), (b), (c), and the carbazolyl-functional linear polysiloxane.

Examples of organic solvents include, but are not limited to, saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; and halogenated aromatic hydrocarbons such as bromobenzene and chlorobenzene. Organic solvent (f) can be a single organic solvent or a mixture comprising two or more different organic solvents, each as defined above.

The reaction can be carried out in any standard reactor suitable for hydrosilylation reactions. Suitable reactors include glass and Teflon-lined glass reactors. Preferably, the reactor is equipped with a means of agitation, such as stirring. Also, preferably, the reaction is carried out in an inert atmosphere, such as nitrogen or argon, in the absence of moisture.

The organohydrogenpolysiloxane, N-alkenyl carbazole, alkenyl silane, alkenyl amine, hydrosilylation catalyst, and organic solvent can be combined in any order. Typically, alkenyl-functional triarylamine (d), alkenyl silane (c), and N-alkenyl carbazole (b) are added sequentially to organohydrogenpolysiloxane (a), and, optionally, organic solvent (f) before the introduction of hydrosilylation catalyst (e).

The reaction is typically carried out at a temperature of from 0 to 250° C., alternatively from room temperature (˜23° C.) to 150° C. When the temperature is less than 0° C., the rate of reaction is typically very slow.

The reaction time depends on several factors, such as the structures of the organohydrogenpolysiloxane, N-alkenyl carbazole, alkenyl silane, and alkenyl amine, and the temperature. The time of reaction is typically from 2 to 48 h at a temperature of from room temperature to 140° C. The optimum reaction time can be determined by routine experimentation using the methods set forth in the Examples section below.

The mole ratio of N-alkenyl carbazole (b) to silicon-bonded hydrogen atoms in organohydrogenpolysiloxane (a) is typically from 0.01 to 1.2, alternatively from 0.5 to 0.95. The mole ratio of alkenyl silane (c) to silicon-bonded hydrogen atoms in organohydrogenpolysiloxane (a) is typically from 0.01 to 0.3, alternatively from 0.05 to 0.2. The mole ratio of alkenyl-functional triarylamine (d) to silicon-bonded hydrogen atoms in organohydrogenpolysiloxane (a) is typically from 0.01 to 1.2, alternatively from 0.05 to 0.6.

The concentration of hydrosilylation catalyst (e) is sufficient to catalyze the addition reaction of organohydrogenpolysiloxane (a) with N-alkenyl carbazole (b), alkenyl silane (c), and alkenyl-functional triarylamine (d). Typically, the concentration of hydrosilylation catalyst (d) is sufficient to provide from 0.1 to 1000 ppm of a platinum group metal, alternatively from 1 to 500 ppm of a platinum group metal, alternatively from 5 to 150 ppm of a platinum group metal, based on the combined weight of organohydrogenpolysiloxane (a), N-alkenyl carbazole (b), alkenyl silane (c), and alkenyl-functional triarylamine (d). The rate of reaction is very slow below 0.1 ppm of platinum group metal. The use of more than 1000 ppm of platinum group metal results in no appreciable increase in reaction rate, and is therefore uneconomical.

The concentration of organic solvent (f) is typically from 0 to 60% (w/w), alternatively from 30 to 60% (w/w), alternatively from 40 to 50% (w/w), based on the total weight of the reaction mixture.

The first linear polysiloxane can be recovered from the reaction mixture by adding sufficient quantity of an alcohol to effect precipitation of the polysiloxane and then filtering the reaction mixture to obtain the polysiloxane. The alcohol typically has from 1 to 6 carbon atoms, alternatively from 1 to 3 carbon atoms. Moreover, the alcohol can have a linear, branched, or cyclic structure. The hydroxy group in the alcohol may be attached to a primary, secondary, or tertiary aliphatic carbon atom. Examples of alcohols include, but are not limited to, methanol, ethanol, 1-propanol, 2-propanol, 1-butanol, 2-butanol, 2-methyl-1-butanol, 1-pentanol, and cyclohexanol.

A second linear polysiloxane according to the present invention comprises from 1 to 99 mol % of units having the formula I, from 1 to 99 mol % of units having the formula III, and units having the formula V: 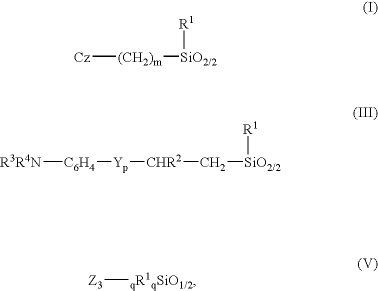
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; Cz is N-carbazolyl; Y is a divalent organic group; Z is a hydrolysable group; m is an integer from 2 to 10; p is 0 or 1; and q is 0, 1, or 2. In formulae I, III, and V, R¹, R², R³, R⁴, Cz, Y, Z, m, and p are as defined and exemplified above for the first linear polysiloxane.

The second linear polysiloxane is a copolymer comprising units having formulae I, III, and V, above. The polysiloxane typically contains from 1 to 99 mol %, alternatively from 5 to 90 mol %, alternatively from 50 to 90 mol %, of units having formula I; and from 1 to 99 mol %, alternatively from 5 to 75 mol %, alternatively from 5 to 50 mol %, of units having formula III. In addition to units having formulae I, III, and V, the second linear polysiloxane may contain up to 30 mol %, alternatively up to 10 mol %, alternatively up to 5 mol %, of other siloxane units. Examples of other siloxane units include, but are not limited to, units having the following formulae: R¹HSiO_{2/2}, R¹₂HSiO_{1/2}, and R¹₂SiO_{2/2} wherein R¹ is as defined and exemplified above.

The second linear polysiloxane typically has a number-average molecular weight of from 1,000 to 1,000,000, alternatively from 2,500 to 150,000, alternatively from 10,000 to 30,000, where the molecular weight is determined by gel permeation chromatography employing a low angle laser light scattering detector.

Examples of the second linear polysiloxane include, but are not limited to, polysiloxanes having the following formulae: [Cz(CH₂)₃Si(Me)O_{2/2}]_{0.79}[HSi(Me)O_{2/2}]_{0.05}[Ph₂NC₆H₄(CH₂)₃Si(Me)O_{2/2}]_{0.15}[(AcO)₃SiO_{1/2}]_{0.01}, [Cz(CH₂)₃Si(Me)O_{2/2}]_{0.80}[HSi(Me)O_{2/2}]_{0.1}[Ph₂NC₆H₄(CH₂)₃Si(Me)O_{2/2}]_{0.08}[(MeO)₃SiO_{1/2}]_{0.02}, [Cz(CH₂)₅Si(Me)O₂O₂]_{0.78}[HSi(Me)O₂O₂]_{0.1}[Ph₂NC₆H₄(CH₂)₃Si(Me)O_{2/2}]_{0.1}[(EtO)₃SiO_{1/2}]_{0.02}, [Cz(CH₂)₃Si(Me)O_{2/2}]_{0.75}[HSi(Me)O_{2/2}]_{0.07}[NAPhNC₆H₄O(CH₂)₂Si(Me)O_{2/2}]_{0.15}[(MeO)₃SiO_{1/2}]_{0.03}, and [Cz(CH₂)₃Si(Et)O_{2/2}]_{0.58}[HSi(Et)O_{2/2}]_{0.15}[Ph₂NC₆H₄(CH₂)₃Si(Et)_{2/2}]_{0.25}[(MeO)₃Si O_{1/2}]_{0.02}, wherein Me is methyl, Et is ethyl, Ph is phenyl, NA is naphthyl, Cz is N-carbazolyl, OAc is acetoxy, and the numerical subscripts denote mole fractions. Also, in the preceding formulae, the sequence of the units is unspecified.

The second linear polysiloxane can be prepared by reacting (a′) an organohydrogenpolysiloxane having the formula Z_{3-q}R¹_{q}SiO(R¹HSiO)ₐSiR¹_{q}Z_{3-q} with (b) an N-alkenyl carbazole having the formula Cz-(CH₂)ₘ₋₂—CH═CH₂ and (d) an alkenyl-functional triarylamine having the formula R³R⁴N—C₆H₄—Yₚ—CR²═CH₂ in the presence of (e) a hydrosilylation catalyst and, optionally, (f) an organic solvent, wherein the subscript a has a value such that the organohydrogenpolysiloxane has a number-average molecular weight of from 240 to 220,00, q is 0, 1, or 2, and R¹, R², R³, R⁴, Cz, Y, Z, m, and p are as defined and exemplified above for the second linear polysiloxane.

Organohydrogenpolysiloxane (a′) has the formula Z_{3-q}R¹_{q}SiO(R¹HSiO)ₐSiR¹_{q}Z_{3-q}, wherein R¹, Z, and q are as defined and exemplified above for the second linear polysiloxane and the subscript a has a value such that the organohydrogenpolysiloxane has a number-average molecular weight of from 240 to 220,00, alternatively from 1,000 to 150,000, alternatively from 1,000 to 75,000.

Examples of organohydrogenpolysiloxanes suitable for use as organohydrogenpolysiloxane (a′) include, but are not limited to, trimethoxysiloxy-terminated poly(methylhydrogensiloxane)s, dimethoxymethylsiloxy-terminated poly(methylhydrogensiloxane)s, methoxydimethylsiloxy-terminated poly(methylhydrogensiloxane)s, triacetoxysiloxy-terminated poly(methylhydrogensiloxane)s, diacetoxymethylsiloxy-terminated poly(methylhydrogensiloxane)s, acetoxydimethylsiloxy-terminated poly(methylhydrogensiloxane)s, trimethoxysiloxy-terminated poly(ethylhydrogensiloxane)s, dimethoxymethylsiloxy-terminated poly(ethylhydrogensiloxane)s, methoxydimethylsiloxy-terminated poly(ethylhydrogensiloxane)s, triacetoxysiloxy-terminated poly(ethylhydrogensiloxane)s, diacetoxymethylsiloxy-terminated poly(ethylhydrogensiloxane)s, acetoxydimethylsiloxy-terminated poly(ethylhydrogensiloxane)s, trimethoxysiloxy-terminated poly(phenylhydrogensiloxane)s, dimethoxymethylsiloxy-terminated poly(phenylhydrogensiloxane)s, methoxydimethylsiloxy-terminated poly(phenylhydrogensiloxane)s, triacetoxysiloxy-terminated poly(phenylhydrogensiloxane)s, diacetoxymethylsiloxy-terminated poly(phenylhydrogensiloxane)s, and acetoxydimethylsiloxy-terminated poly(phenylhydrogensiloxane)s.

Methods of preparing organohydrogenpolysiloxanes having terminal hydrolysable groups are well known in the art. For example the organohydrogenpolysiloxanes can be prepared by reacting an alkoxy-terminated organohydrogenpolysiloxane with a silane having the formula XSiR¹_{q}Z_{3-q}, wherein X is Z or —OH, and R¹, Z, and q are as defined and exemplified above for the second linear polysiloxane.

N-alkenyl carbazole (b), alkenyl-functional triarylamine (d), hydrosilylation catalyst (e), and organic solvent (f) are as described and exemplified above in the method of preparing the first linear polysiloxane.

The reaction for preparing the second linear polysiloxane can be carried out in the manner described above for preparing the first linear polysiloxane, except the mole ratio of N-alkenyl carbazole (b) to silicon-bonded hydrogen atoms in organohydrogenpolysiloxane (a′) is typically from 0.01 to 1.2, alternatively from 0.6 to 1.0; and the mole ratio of alkenyl-functional triarylamine (d) to silicon-bonded hydrogen atoms in organohydrogenpolysiloxane (a′) is typically from 0.01 to 1.2, alternatively from 0.05 to 0.7. Furthermore, the second linear polysiloxane can be recovered from the reaction mixture as described above for the first linear polysiloxane.

A third linear polysiloxane according to the present invention comprises from 1 to 99 mol % of units having the formula I, from 1 to 99 mol % of units having the formula III, and units having the formula VI: 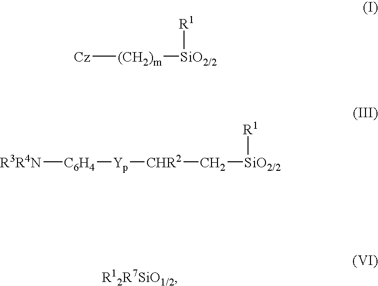
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; Cz is N-carbazolyl; each R⁷ is independently R¹, —H, —(CH₂)ₘ-Cz, or —CH₂—CHR²—Yₚ—C₆H₄—NPh₂, Cz is N-carbazolyl; Y is a divalent organic group; m is an integer from 2 to 10; and p is 0 or 1. In formulae I, III, and VI, R¹, R², R³, R⁴, Cz, Y, m, and p are as defined and exemplified above for the first linear polysiloxane.

The third linear polysiloxane is a copolymer comprising units having formulae I, III, and VI, above. The polysiloxane contains from 1 to 99 mol %, alternatively from 5 to 90 mol %, alternatively from 50 to 90 mol %, of units having formula I; and from 1 to 99 mol %, alternatively from 5 to 75 mol %, alternatively from 5 to 50 mol %, of units having formula III. In addition to units having formulae I, III, and VI, the third linear polysiloxane may contain up to 30 mol %, alternatively up to 10 mol %, alternatively up to 5 mol %, of other siloxane units. Examples of other siloxane units include, but are not limited to, units having the following formulae: R¹HSiO_{2/2}, R¹₂HSiO_{1/2}, and R¹₂SiO_{2/2}, wherein R¹ is as defined and exemplified above.

The third linear polysiloxane typically has a number-average molecular weight of from 1,000 to 1,000,000, alternatively from 2,500 to 150,000, alternatively from 10,000 to 30,000, where the molecular weight is determined by gel permeation chromatography employing a low angle laser light scattering detector.

Examples of the third linear polysiloxane include, but are not limited to, polysiloxanes having the following average formulae: [Cz(CH₂)₃Si(Me)O_{2/2}]_{0.79}[HSi(Me)O_{2/2}]_{0.05}[Ph₂NC₆H₄(CH₂)₃Si(Me)O_{2/2}]_{0.15}[(Me₃SiO_{1/2}]_{0.01}, [Cz(CH₂)₃Si(Me)O_{2/2}]_{0.80}[HSi(Me)O_{2/2}]_{0.1}[Ph₂NC₆H₄(CH₂)₃Si(Me)O_{2/2}]_{0.08}[(Me₃SiO_{1/2}]_{0.02}, [Cz(CH₂)₅Si(Me)O_{2/2}]_{0.78}[HSi(Me)O_{2/2}]_{0.1}[Ph₂NC₆H₄(CH₂)₃Si(Me)O_{2/2}]_{0.1}[HMe₂SiO_{1/2}]_{0.02}, [Cz(CH₂)₃Si(Me)O_{2/2}]_{0.75}[HSi(Me)O_{2/2}]_{0.07}[NAPhNC₆H₄—O—(CH₂)₂Si(Me)O_{2/2}]_{0.15}[(PhMe₂SiO_{1/2}]_{0.03}, [Cz(CH₂)₃Si(Et)O_{2/2}]_{0.58}[HSi(Et)O_{2/2}]_{0.15}[Ph₂NC₆H₄(CH₂)₃Si(Et)O_{2/2}]_{0.25}[(Me₃SiO_{1/2}]_{0.02}, wherein Me is methyl, Et is ethyl, Ph is phenyl, NA is naphthyl, Cz is N-carbazolyl, and the numerical subscripts denote mole fractions. Also, in the preceding formulae, the sequence of the units is unspecified.

The third linear polysiloxane can be prepared by reacting (a) an organohydrogenpolysiloxane having the formula R²R¹₂SiO(R¹HSiO)ₐSiR¹₂R² with (b) an N-alkenyl carbazole having the formula Cz-(CH₂)ₘ₋₂—CH═CH₂ and (d) an alkenyl-functional triarylamine having the formula R³R⁴N—C₆H₄—Yₚ—CR²—CH₂ in the presence of (e) a hydrosilylation catalyst and, optionally, (f) an organic solvent, wherein the subscript a has a value such that the organohydrogenpolysiloxane has a number-average molecular weight of from 240 to 220,00, and R¹, R², R³, R⁴, Cz, Y, m, and p are as defined and exemplified above for the third linear polysiloxane.

Organohydrogenpolysiloxane (a), N-alkenyl carbazole (b), alkenyl-functional triarylamine (d), hydrosilylation catalyst (d), and organic solvent (f) are as described and exemplified above in the method of preparing the first linear polysiloxane.

The reaction for preparing the third linear polysiloxane can be carried out in the manner described above for preparing the first linear polysiloxane, except the mole ratio of N-alkenyl carbazole (b) to silicon-bonded hydrogen atoms in organohydrogenpolysiloxane (a) is typically from 0.01 to 1.2, alternatively from 0.6 to 1.0; and the mole ratio of alkenyl-functional triarylamine (d) to silicon-bonded hydrogen atoms in organohydrogenpolysiloxane (a) is typically from 0.01 to 1.2, alternatively from 0.05 to 0.7. Furthermore, the third linear polysiloxane can be recovered from the reaction mixture as described above for the first linear polysiloxane.

A silicone composition according to the present invention comprises:

(A) a polysiloxane selected from (i) at least one linear polysiloxane comprising from 1 to 99 mol % of units having the formula I, from 1 to 20 mol % of units having the formula II, 1 to 99 mol % of units having formula III, and units having the formula IV: 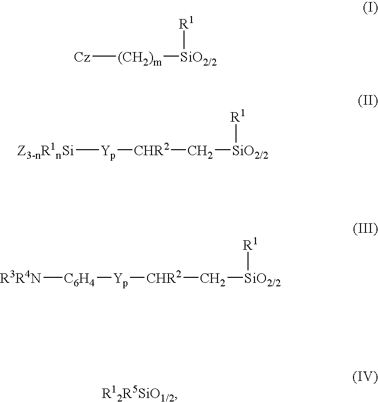
(ii) at least one linear polysiloxane comprising from 1 to 99 mol % of units having the formula I, from 1 to 99 mol % of units having the formula III, and units having the formula V: 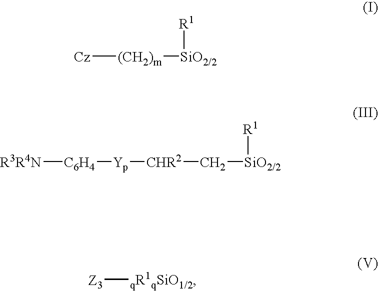
and (iii) a mixture comprising (i) and (ii), wherein R¹ is C₁ to C₁₀ hydrocarbyl free of aliphatic unsaturation; R² is R¹ or —H, R³ and R⁴ are aryl or together with the nitrogen atom to which they are attached are 10(9H)-acridinyl or 10,11-dihydro-5H-dibenz[b,f]azepin-5-yl, each R⁵ is independently R¹, —H, —(CH₂)ₘ-Cz, —CH₂—CHR²—Yₚ—SiR¹ₙZ₃₋ₙ, or —CH₂—CHR²—Yₚ—C₆H₄—NR⁴R³, Cz is N-carbazolyl, Y is a divalent organic group, Z is a hydrolysable group, m is an integer from 2 to 10, n is 0, 1, or 2, and p is 0 or 1, and q is 0, 1, or 2;

(B) a condensation catalyst; and

(C) an organic solvent.

Components (A)(i) and (A)(ii) are the first linear polysiloxane and the second linear polysiloxane, respectively, described and exemplified above.

Component (B) is at least one condensation catalyst. The condensation catalyst can be any condensation catalyst typically used to promote condensation of silicon-bonded hydroxy (silanol) groups to form Si—O—Si linkages. Examples of condensation catalysts include, but are not limited to, tin(II) and tin(IV) compounds such as tin dilaurate, tin dioctoate, and tetrabutyl tin; and titanium compounds such as titanium tetrabutoxide.

When present, the concentration of the condensation catalyst is typically from 0.1 to 10% (w/w), alternatively from 0.5 to 5% (w/w), alternatively from 1 to 3% (w/w), based on the total weight of component (A).

Component (C) is at least one organic solvent. Examples of organic solvents include, but are not limited to, aromatic hydrocarbons such as benzene, toluene, xylene and mesitylene; cyclic ethers such as tetrahydrofuran (THF) and dioxane; ketones such as methyl isobutyl ketone (MIBK), cyclopentanone, and cyclohexanone; halogenated alkanes such as trichloroethane; and halogenated aromatic hydrocarbons such as bromobenzene and chlorobenzene. Component (C) can be a single organic solvent or a mixture comprising two or more different organic solvents, each as defined above. The concentration of the organic solvent is typically from 70 to 99% (w/w), alternatively from 85 to 99% (w/w), based on the total weight of the silicone composition.

When the silicone composition comprises, component (A)(ii), wherein q has a value of 2, the composition typically further comprises a cross-linking agent having the formula R⁸_{w}SiZ_{4-w}, wherein R⁸ is C₁ to C₈ hydrocarbyl or halogen-substituted hydrocarbyl, Z is as defined and exemplified above for the first linear polysiloxane and w is 0 or 1. Examples of cross-linking agents include, but are not limited to, alkoxy silanes such as MeSi(OCH₃)₃, CH₃Si(OCH₂CH₃)₃, CH₃ Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH₂═CHSi[O—N═C(CH₃)CH₂CH₃]₃; organoacetamidosilanes such as CH₃Si[NHC(—O)CH₃]₃ and C₆H₅Si[NHC(═O)CH₃]₃; amino silanes such as CH₃Si[NH(s-C₄H₉)]₃ and CH₃Si(NHC₆H₁₁)₃; and organoaminooxysilanes.

The cross-linking agent can be a single silane or a mixture of two or more different silanes, each as described above. Also, methods of preparing tri- and tetra-functional silanes are well known in the art; many of these silanes are commercially available.

When present, the concentration of the cross-linking agent in the silicone composition is sufficient to cure (cross-link) the composition. The exact amount of the cross-linking agent depends on the desired extent of cure, which generally increases as the ratio of the number of moles of silicon-bonded hydrolysable groups in the cross-linking agent to the number of moles of hydrolysable groups Z in the second linear polysiloxane increases. Typically, the concentration of the cross-linking agent is sufficient to provide from 0.9 to 1.0 silicon-bonded hydrolysable groups per hydrolysable group in the second linear polysiloxane. The optimum amount of the cross-linking agent can be readily determined by routine experimentation.

The silicone composition of the instant invention is typically prepared by combining components (A), (B), (C) and any optional ingredients in the stated proportions at ambient temperature.

Mixing can be accomplished by any of the techniques known in the art such as milling, blending, and stirring, either in a batch or continuous process. The particular device is determined by the viscosity of the components and the viscosity of the final silicone composition.

A first organic light-emitting diode according to the present invention comprises:

a substrate having a first opposing surface and a second opposing surface;

a first electrode layer overlying the first opposing surface;

a light-emitting element overlying the first electrode layer, the light emitting element comprising
a hole-transport layer and
an emissive/electron-transport layer, wherein the hole-transport layer and the emissive/electron transport layer lie directly on one another, and the hole-transport layer comprises a cured polysiloxane prepared by applying the aforementioned silicone composition to form a film and curing the film; and

a second electrode layer overlying the light-emitting element.

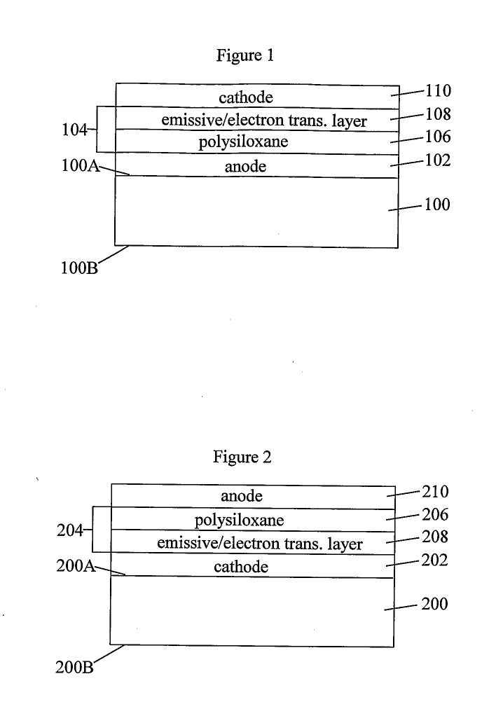

As used herein, the term “overlying” used in reference to the position of the first electrode layer, light-emitting element, and second electrode layer relative to the designated component means the particular layer either lies directly on the component or lies above the component with one or more intermediary layers there between, provided the OLED is oriented with the substrate below the first electrode layer as shown in FIGS. 1 and 2. For example, the term “overlying” used in reference to the position of the first electrode layer relative to the first opposing surface of the substrate in the OLED means the first electrode layer either lies directly on the surface or is separated from the surface by one or more intermediate layers.

The substrate can be a rigid or flexible material having two opposing surfaces. Further, the substrate can be transparent or nontransparent to light in the visible region of the electromagnetic spectrum. As used herein, the term “transparent” means the particular component (e.g., substrate or electrode layer) has a percent transmittance of at least 30%, alternatively at least 60%, alternatively at least 80%, for light in the visible region (˜400 to ˜700 μm) of the electromagnetic spectrum. Also, as used herein, the term “nontransparent” means the component has a percent transmittance less than 30% for light in the visible region of the electromagnetic spectrum.

Examples of substrates include, but are not limited to, semiconductor materials such as silicon, silicon having a surface layer of silicon dioxide, and gallium arsenide; quartz; fused quartz; aluminum oxide; ceramics; glass; metal foils; polyolefins such as polyethylene, polypropylene, polystyrene, and polyethyleneterephthalate; fluorocarbon polymers such as polytetrafluoroethylene and polyvinylfluoride; polyamides such as Nylon; polyimides; polyesters such as poly(methyl methacrylate); epoxy resins; polyethers; polycarbonates; polysulfones; and polyether sulfones.

The first electrode layer can function as an anode or cathode in the OLED. The first electrode layer may be transparent or nontransparent to visible light. The anode is typically selected from a high work-function (>4 eV) metal, alloy, or metal oxide such as indium oxide, tin oxide, zinc oxide, indium tin oxide (ITO), indium zinc oxide, aluminum-doped zinc oxide, nickel, and gold. The cathode can be a low work-function (<4 eV) metal such as Ca, Mg, and Al; a high work-function (>4 eV) metal, alloy, or metal oxide, as described above; or an alloy of a low-work function metal and at least one other metal having a high or low work-function, such as Mg—Al, Ag—Mg, Al—Li, In—Mg, and Al—Ca. Methods of depositing anode and cathode layers in the fabrication of OLEDs, such as evaporation, co-evaporation, DC magnetron sputtering, or RF sputtering, are well known in the art.

The light-emitting element layer overlies the first electrode layer. The light-emitting element comprises a hole-transport layer and an emissive/electron-transport layer, wherein the hole-transport layer and the emissive/electron-transport layer lie directly on one another, and the hole-transport layer comprises a cured polysiloxane prepared by applying the silicone composition of the present invention to form a film and curing the film. The orientation of the light-emitting element depends on the relative positions of the anode and cathode in the OLED. The hole-transport layer is located between the anode and the emissive/electron-transport layer and the emissive/electron-transport layer is located between the hole-transport layer and the cathode. The thickness of the hole-transport layer is typically from 2 to 100 nm, alternatively from 30 to 50 nm. The thickness of the emissive/electron-transport layer is typically from 20 to 100 nm, alternatively from 30 to 70 nm.

The hole-transport layer comprises a cured polysiloxane prepared by applying a silicone composition to form a film and curing the film, wherein the silicone composition comprises components (A) through (C), described above. The silicone composition can be applied to the first electrode layer, a layer overlying the first electrode layer, or the emissive/electron-transport layer, depending on the configuration of the OLED, to form a film, using conventional methods such as spin-coating, dipping, spraying, brushing, and printing.

The film can be cured by exposing it to moisture. Formation of the cured polysiloxane can be accelerated by application of heat and/or exposure to high humidity. The rate of formation of the cured polysiloxane depends on a number of factors, including temperature, humidity, structure of the silane, and nature of the hydrolysable groups. For example, the cured polysiloxane is typically formed by exposing the film to a relative humidity of about 30% at a temperature of from about room temperature (23° C.) to about 150° C., for period from 0.5 to 72 h.

The emissive/electron-transport layer can be any low molecular weight organic compound or organic polymer typically used as an emissive, electron-transport, electron-injection/electron-transport, or light-emitting material in OLED devices. Low molecular weight organic compounds suitable for use as the electron-transport layer are well known in the art, as exemplified in U.S. Pat. No. 5,952,778; U.S. Pat. No. 4,539,507; U.S. Pat. No. 4,356,429; U.S. Pat. No. 4,769,292; U.S. Pat. No. 6,048,573; and U.S. Pat. No. 5,969,474. Examples of low molecular weight compounds include, but are not limited to, aromatic compounds, such as anthracene, naphthalene, phenanthrene, pyrene, chrysene, and perylene; butadienes such as 1,4-diphenylbutadiene and tetraphenylbutadiene; coumarins; acridine; stilbenes such as trans-stilbene; and chelated oxinoid compounds, such as tris(8-hydroxyquinolato)aluminum(III), Alq₃. These low molecular weight organic compounds may be deposited by standard thin-film preparation techniques including vacuum evaporation and sublimation.

Organic polymers suitable for use as the emissive/electron-transport layer are well known in the art, as exemplified in U.S. Pat. No. 5,952,778; U.S. Pat. No. 5,247,190; U.S. Pat. No. 5,807,627; U.S. Pat. No. 6,048,573; and U.S. Pat. No. 6,255,774. Examples of organic polymers include, but are not limited to, poly(phenylene vinylene)s, such as poly(1,4 phenylene vinylene); poly-(2,5-dialkoxy-1,4 phenylene vinylene)s, such as poly(2-methoxy-5-(2-ethylhexyloxy)-1,4-phenylenevinylene) (MEHPPV), poly(2-methoxy-5-(2-methylpentyloxy)-1,4-phenylenevinylene), poly(2-methoxy-5-pentyloxy-1,4-phenylenevinylene), and poly(2-methoxy-5-dodecyloxy-1,4-phenylenevinylene); poly(2,5-dialkyl-1,4 phenylene vinylene)s; poly(phenylene); poly(2,5-dialkyl-1,4 phenylene)s; poly(p-phenylene); poly(thiophene)s, such as poly(3-alkylthiophene)s; poly(alkylthienylene)s, such as poly(3-dodecylthienylene); poly(fluorene)s, such as poly(9,9-dialkyl fluorine)s; and polyanilines. Examples of organic polymers also include the polyfluorene-based light-emitting polymers available from The Dow Chemical Company (Midland, Mich.), under the trademark LUMATION, such as LUMATION Red 1100 Series Light-Emitting Polymer, LUMATION Green 1300 Series Light-Emitting Polymer, and LUMATION Blue BP79 Light Emitting Polymer. The organic polymers can be applied by conventional solvent coating techniques such as spin-coating, dipping, spraying, brushing, and printing (e.g., stencil printing and screen printing). and screen printing).

The emissive/electron-transport layer can further comprise a fluorescent dye. Fluorescent dyes suitable for use in OLED devices are well known in the art, as illustrated in U.S. Pat. No. 4,769,292. Examples of fluorescent dyes include, but are not limited to, coumarins; dicyanomethylenepyrans, such as 4-(dicyanomethylene)-2-methyl-6-(p-dimethylaminostyryl)4H-pyran; dicyanomethylenethiopyrans; polymethine; oxabenzanthracene; xanthene; pyrylium and thiapyrylium; cabostyril; and perylene fluorescent dyes.

The second electrode layer can function either as an anode or cathode in the OLED. The second electrode layer may be transparent or nontransparent to light in the visible region. Examples of anode and cathode materials and methods for their formation are as described above for the first electrode layer.

The OLED of the present invention can further comprise a hole-injection layer interposed between the anode and the hole-transport layer, and/or an electron-injection layer interposed between the cathode and the emissive/electron-transport layer. The hole-injection layer typically has a thickness of from 5 to 20 nm, alternatively from 7 to 10 μm. Examples of materials suitable for use as the hole-injection layer include, but are not limited to, copper phthalocyanine. The electron-injection layer typically has a thickness of from 0.5 to 5 nm, alternatively from 1 to 3 nm. Examples of materials suitable for use as the electron-injection layer include, but are not limited to, alkali metal fluorides, such as lithium fluoride and cesium fluoride; and alkali metal carboxylates, such as lithium acetate and cesium acetate. The hole-injection layer and the hole-injection layer can be formed by conventional techniques, thermal evaporation.

A second organic light-emitting diode according to the present invention comprises:

a substrate having a first opposing surface and a second opposing surface;

a first electrode layer overlying the first opposing surface;

a light-emitting element overlying the first electrode layer, the light emitting element comprising
a hole-transport layer and
an emissive/electron-transport layer, wherein the hole-transport layer and the emissive/electron transport layer lie directly on one another, and the hole-transport layer comprises the third linear polysiloxane; and

a second electrode layer overlying the light-emitting element.

In the second organic light-emitting diode, the substrate, the first electrode layer, the emissive/electron-transport layer, and the second electrode layer are as described and exemplified above for the first OLED. The hole-transport layer comprises the third linear polysiloxane described and exemplified above. The hole-transport layer can be formed by applying the third polysiloxane, with or without the aid of an organic solvent, to the first electrode layer, a layer overlying the first electrode layer, or the emissive/electron-transport layer, depending on the configuration of the OLED, to form a film, using conventional methods such as spin-coating, dipping, spraying, brushing, and printing.

As shown in FIG. 1, a first embodiment of an OLED according to the present invention comprises a substrate 100 having a first opposing surface 100A and a second opposing surface 100B, a first electrode layer 102 on the first opposing surface 100A, wherein the first electrode layer 102 is an anode, a light-emitting element 104 overlying the first electrode layer 102, wherein the light-emitting element 104 comprises a hole-transport layer 106 and an emissive/electron-transport layer 108 lying directly on the hole-transport layer 106, wherein the hole-transport layer 106 comprises a cured polysiloxane or a linear polysiloxane, and a second electrode layer 110 overlying the light-emitting element 104, wherein the second electrode layer 110 is a cathode.

As shown in FIG. 2, a second embodiment of an OLED according to the present invention comprises a substrate 200 having a first opposing surface 200A and a second opposing surface 200B, a first electrode layer 202 on the first opposing surface 200A, wherein the first electrode layer 202 is a cathode, a light-emitting element 204 overlying the first electrode layer 202, wherein the light-emitting element 204 comprises an emissive/electron-transport layer 208 and a hole-transport layer 206 lying directly on the emissive/electron-transport layer 206, wherein the hole-transport layer 206 comprises a cured polysiloxane or a linear polysiloxane, and a second electrode layer 210 overlying the light-emitting element 204, wherein the second electrode layer 210 is an anode.

The linear polysiloxanes of the present invention exhibit electroluminescence, emitting light when subjected to an applied voltage. Moreover, the linear polysiloxanes containing hydrolysable groups can be cured to produce durable cross-linked polysiloxanes. Also, the linear polysiloxanes can be doped with small amounts of fluorescent dyes to enhance the electroluminescent efficiency and control the color output of the cured polysiloxane.

The silicone composition of the present invention can be conveniently formulated as a one-part composition. Moreover, the silicone composition has good shelf-stability in the absence of moisture. Importantly, the composition can be applied to a substrate by conventional high-speed methods such as spin coating, printing, and spraying. Also, the silicone composition can be readily cured by exposure to moisture at mild to moderate temperatures.

The cured polysiloxane of the present invention exhibits electroluminescence. Moreover, the cured polysiloxane has good primeness adhesion to a variety of substrates. The cured polysiloxane also exhibits excellent durability, chemical resistance, and flexibility at low temperatures. Additionally, the cured polysiloxane exhibits high transparency, typically at least 95% transmittance at a thickness of 100 nm, in the visible region of the electromagnetic spectrum. Importantly, the polysiloxane is substantially free of acidic or basic components, which are detrimental to the electrode and light-emitting layers in OLED devices.

The OLED of the present invention exhibits good resistance to abrasion, organic solvents, moisture, and oxygen. Moreover, the OLED exhibits high quantum efficiency, low turn-on voltage, and photostability.

The OLED is useful as a discrete light-emitting device or as the active element of light-emitting arrays or displays, such as flat panel displays. OLED displays are useful in a number of devices, including watches, telephones, lap-top computers, pagers, cellular phones, digital video cameras, DVD players, and calculators.

### EXAMPLES

The following examples are presented to better illustrate the linear polysiloxanes, silicone composition, and OLED of the present invention, but are not to be considered as limiting the invention, which is delineated in the appended claims. Unless otherwise noted, all parts and percentages reported in the examples are by weight. The following methods and materials were employed in the examples:

Infrared Spectra

Infrared spectra were recorded on a Perkin Elmer Instruments 1600 FT-IR spectrometer.

NMR Spectra

Nuclear magnetic resonance spectra (¹H NMR, ¹³C NMR, and ²⁹Si NMR) were obtained using a Varian Mercury 400 MHz NMR spectrometer.

Method of Cleaning ITO-Coated Glass Substrates

ITO-coated glass slides (Merck Display Technology, Inc., Taipei, Taiwan) having a surface resistance of 10 Ω/square were cut into 25-mm square substrates. The substrates were immersed in an ultrasonic bath containing a solution consisting of 1% Alconox powdered cleaner (Alconox, Inc.) in water for 10 min and then rinsed with deionized water. The substrates were then immersed sequentially in the each of the following solvents with ultrasonic agitation for 10 min in each solvent: isopropyl alcohol, n-hexane, and toluene. The glass substrates were then dried under a stream of dry nitrogen and treated with O2 plasma for 3 minutes immediately before use.

Deposition of SiO in OLEDs

Silicon monoxide (SiO) was deposited by thermal evaporation using a BOC Edwards Auto 306 high vacuum deposition system equipped with a crystal balance film thickness monitor. The substrate was placed in a rotary sample holder positioned above the source and covered with the appropriate mask. The source was prepared by placing a sample of the organic compound or SiO in an aluminum oxide crucible. The crucible was then positioned in a tungsten wire spiral. The pressure in the vacuum chamber was reduced to 2.0×10⁻⁶ mbar. The substrate was allowed to outgas for at least 30 minutes at this pressure. The organic or SiO film was deposited by heating the source via the tungsten filament while rotating the sample holder. The deposition rate (0.1 to 0.3 nm per second) and the thickness of the film were monitored during the deposition process.

Deposition of LiF, Ca, and Al Films in OLEDs

LiF, Ca or Aluminum films were deposited by thermal evaporation under an initial vacuum of 10⁻⁶ mbar using a BOC Edwards model E306A Coating System equipped with a crystal balance film thickness monitor. The source was prepared by placing the metal in an aluminum oxide crucible and positioning the crucible in a tungsten wire spiral, or by placing the metal directly in a tungsten basket. When multiple layers of different metals were required, the appropriate sources were placed in a turret that could be rotated for deposition of each metal. The deposition rate (0.1 to 0.3 nm per second) and the thickness of the film were monitored during the deposition process.

LUMATION Blue BP79 Light Emitting Polymer, available from The Dow Chemical Company (Midland, Mich.), is a polyfluorene polymer that emits light in the blue region of the visible spectrum.

### Example 1

### Preparation of N-(3-allylphenyl)-N,N-diphenylamine

Dry toluene (60 mL), 36 g (213 mmol) of diphenylamine, and 100 g (424 mmol) of 1,3-dibromobenzene were combined under nitrogen in a dry 500-mL flask equipped with a magnetic stirrer and a thermometer. To the well-stirred solution, was added 24 g (249 mmol) of sodium t-butoxide, 0.41 g (0.447 mmol) of tris(dibenzylideneacetone)dipalladium(0), and 0.83 g (1.333 mmol) of BINAP [2,2′-bis(diphenylphosphino)-1,1′-binaphthyl]. The mixture was heated to about 80° C. and the progress of the reaction was monitored by periodically withdrawing an aliquot of the mixture for analysis by gas chromatography. After 7 h, the reaction mixture was cooled to room temperature, diluted with 100 mL of ether and filtered.

The filtrate was distilled under reduced pressure to remove excess 1,3-dibromobenzene. The residue was diluted with 200 mL of hexane, treated with 100 g of silica gel, and heated at 60° C. for 10 min. The mixture was filtered and hexane was removed by evaporation under reduced pressure. The viscous residue was kept at room temperature overnight and then washed with hexane (2×25 mL) to form a precipitate. The precipitate was collected by filtration, washed with a minimum amount of hexane, and dried in vacuo to give N-(3-bromophenyl)-N,N-diphenylamine. The identity of the product was confirmed by IR, ¹H NMR, and ¹³C NMR spectrometry.

A solution consisting of 40 g (0.125 mole) of N-(3-bromophenyl)-N,N-diphenylamine in 120 mL of dry THF was added drop-wise to a stirred mixture consisting of 3 g (0.125 mole) of magnesium turnings, 15 mL of dry THF, and about 20 mg of iodine under reflux. After 4.5 h, 15.2 g (0.125 mole) of allyl bromide was added drop-wise to the mixture. The reaction was continued over night. The mixture was allowed to cool to room temperature, diluted with 100 mL of ether and filtered. The stirred filtrate was treated with 4.0 mL of deionized water and 150 g of silica gel at about 60° C. and then filtered through anhydrous magnesium sulfate. Removal of solvent and distillation under reduced pressure (150-155° C./0.67 Pa) gave N-(3-allylphenyl)-N,N-diphenylamine. The identity of the product was confirmed by IR, ¹H NMR, and ¹³C NMR spectrometry.

### Example 2

### Preparation of N-(4-allylphenyl)-N,N-diphenylamine

N-bromosuccinimide (74 g, 0.414 mol) was added to a stirred solution consisting of 100 g (0.410 mol) of triphenylamine in 800 mL of carbon tetrachloride under nitrogen in a 2.0-L two-neck flask. The reaction mixture was heated to about 65-70° C. and maintained under mild reflux for 15 hrs. After cooling the reaction mixture to room temperature, succinimide was removed by filtration, and most of the solvent was removed by distillation. Methanol was added to the mixture to form a precipitate, which was dissolved in a minimum volume of chloroform. The solution was filtered to remove excess succinimide and methanol was added to the filtrate to form a precipitate. The precipitate was then dissolved in a 1:1 (v/v) mixture of hexane and ether and the stirred mixture was treated with 100 g of silica gel. The silica gel was removed by filtration and methanol was added to the filtrate to form a precipitate. The precipitate was dried under vacuum to give N-(4-allylphenyl)-N,N-diphenylamine (77% yield). The identity of the compound was confirmed by IR, ¹H NMR, and ¹³C NMR spectrometry.

A solution of 50 g (0.154 mole) of N-(4-bromophenyl)-N,N-diphenylamine in 150 mL of dry THF was added drop-wise to a stirred mixture consisting of 3.7 g (0.154 mole) of magnesium turnings, 15 mL dry THF, and about 15 mg of iodine under mild reflux. After 5.5 h, 19.6 g (0.162 mole) of allyl bromide was added drop-wise to the mixture. The reaction was continued over night. The mixture was allowed to cool to room temperature, diluted with 200 mL of ether and filtered. The stirred filtrate was treated with 5.0 mL of deionized water and 200 g of silica gel and then filtered through anhydrous magnesium sulfate. Removal of solvent and distillation under reduced pressure (155-160° C./0.67 Pa) gave N-(4-allylphenyl)-N,N-diphenylamine (79% yield). The identity of the product was confirmed by IR, ¹H NMR, and ¹³C NMR.

### Example 3

### Preparation of 9-[3-(trichlorosilyl)ethyl]-9H-carbazole

Trichlorosilane (4.47 g), 5.52 g of allyl carbazole, and 5.5 g of anhydrous toluene were combined under nitrogen in a one-neck glass flask equipped with a magnetic stir bar. To the mixture was added 0.015 g of a solution consisting of 0.31% of 1,3-divinyl-1,1,3,3-tetramethyldisiloxane and 0.19% of a platinum complex of 1,3-divinyl-1,1,3,3-tetramethyldisiloxane in dry toluene. The mixture was heated under nitrogen at 60° C. for 1 h and then flushed with dry nitrogen for 10 min. The mixture was then distilled at about 220° C. under vacuum to produce 9-[3-(trichlorosilyl)ethyl]-9H-carbazole as a fluid, which formed transparent colorless crystals upon cooling to room temperature.

### Example 4

### Preparation of a Linear Polysiloxane

Allyl carbazole (2.31 g), 0.7 g of a trimethylsiloxy-terminated poly(methylhydrogensiloxane) having a dp of 115, and 0.35 g of N-(3-allylphenyl)-N,N-diphenylamine were combined. The mixture was thoroughly mixed, heated to 70° C., and treated with 0.01 g of a solution consisting of 0.31% of 1,3-divinyl-1,1,3,3-tetramethyldisiloxane and 0.19% of a platinum(IV) complex of 1,3-divinyl-1,1,3,3-tetramethyldisiloxane in toluene was added to the mixture using a syringe. The mixture was heated at 130° C. for 3 h and then allowed to cool to room temperature. The resulting solid was extracted with 20 mL of electronic grade hexane to remove unreacted starting materials. The solid was then dissolved in 3 mL of electronic grade toluene and the crude polysiloxane was precipitated by addition of 20 mL of 2-propanol (electronic grade). This dissolution/precipitation process was repeated three times. The polysiloxane was dissolved in toluene to give a solution having a solid content of 21.4% (w/w). The polysiloxane contained about 5 mol % of siloxane units having the formula Ph₂N—C₆H₄—CH₂CH₂CH₂Si(Me)_{2/2}, 77 mol % of units having the formula Cz-(CH₂)₃—Si(Me)O_{2/2}, and 18 mol % of units having the formula HMeSiO_{2/2}, as determined by ¹³C NMR and ²⁹Si NMR.

### Example 5

### Preparation of a Linear Polysiloxane

Allyl carbazole (2.3 g), 1.4 g of a trimethylsiloxy-terminated poly(methylhydrogensiloxane) having a dp of 115, and 1.1 g of N-(4-allylphenyl)-N,N-diphenylamine were combined. The mixture was thoroughly mixed, heated to 70° C., and treated with 0.01 g of a solution consisting of 0.31% of 1,3-divinyl-1,1,3,3-tetramethyldisiloxane and 0.19% of a platinum(IV) complex of 1,3-divinyl-1,1,3,3-tetramethyldisiloxane in toluene was added to the mixture using a syringe. The mixture was heated to 130° C. and maintained at that temperature for 3 h. The mixture was treated with 2.3 g of allyl carbazole and maintained at 130° C. for an additional 2 h. The resulting solid was extracted with 30 mL of electronic grade hexane to remove unreacted starting materials. The solid was then dissolved in 6 mL of electronic grade toluene and the crude polysiloxane was precipitated by addition of 30 mL of 2-propanol (electronic grade). This dissolution/precipitation process was repeated three times, after which time the polysiloxane was dried in a vacuum oven. The polysilxoane contained about 7.8 mol % of siloxane units having the formula Ph₂N—C₆H₄—CH₂CH₂CH₂Si(Me)O_{2/2}, 78.5 mol % of units having the formula Cz-(CH₂)₃—Si(Me)O_{2/2}, and 13.7 mol % of units having the formula HMeSiO_{2/2}, as determined by ¹³C NMR and ²⁹Si NMR.

### Example 6

### Preparation of OLEDs

Four OLEDs (see figures below) were fabricated as follows: Silicon monoxide (100 m) was thermally deposited along a first edge of a pre-cleaned ITO-coated glass substrate (25 mm×25 mm) through a mask having a rectangular aperture (6 mm×25 mm). The slide was then exposed to O₂ plasma for 3 minutes in the high vacuum chamber. A strip of 3M Scotch brand tape (5 mm×25 mm) was applied along a second edge of the substrate, perpendicular to the SiO deposit. After treatment of the ITO surface with O₂ plasma for 3 min, a solution consisting of 0.1% of 9-[3-(trichlorosilyl)ethyl]-9H-carbazole in toluene was spin-coated (4200 rpm, 20 s) over the ITO surface using a CHEMAT Technology Model KW-4A spin-coater. The trichlorosilane layer was heated in an oven under the air at 100° C. for 30 min and then allowed to cool to room temperature. A solution consisting of 3% of the linear polysiloxane of Example 4 in cyclopentanone was spin-coated (4,000 rpm) over the treated ITO surface to form a hole-transport layer having a thickness of about 45 nm. The composite was heated in an oven at 100° C. and then allowed to cool to room temperature. A solution consisting of 1.5% of LUMATION Blue BP79 Light-Emitting Polymer in mesitylene was then spin-coated (2250 rpm, 40 second) over the hole-transport layer to form an emissive/electron-transport layer having a thickness of about 50 nm. The composite was heated in an oven under nitrogen at 100° C. for 30 min and then allowed to cool to room temperature. The strip of tape was removed from the substrate to expose the anode (ITO) and four cathodes were formed by depositing lithium fluoride (1 μm), calcium (50 μm) and aluminum (150 nm) sequentially on top of the light-emitting polymer layer and SiO deposit through a mask having four rectangular apertures (3 mm×16 mm). Each of the four OLEDs emitted a blue color light and had a turn-on voltage at 1 cd m⁻² of about 2.9 V, a brightness at 10 V of approximately 10000 cd m⁻², and a peak luminous efficiency of 3.8 cd A⁻¹.

[image]

That which is claimed is:

1. A linear polysiloxane comprising from 1 to 99 mol % of units having the formula I, from 1 to 20 mol % of units having the formula II, 1 to 99 mol % of units having formula III, and units having the formula IV: 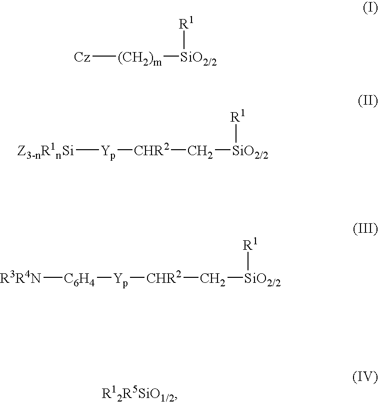
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; each R⁵ is independently R¹, —H, —(CH₂)ₘ-Cz, —CH₂—CHR²—Yₚ—SiR¹ₙZ₃₋ₙ, or —CH₂—CHR²—Yₚ—C₆H₄—NR⁴R³, Cz is N-carbazolyl; Y is a divalent organic group; Z is a hydrolysable group; m is an integer from 2 to 10; n is 0, 1, or 2; and p is 0 or 1.

2. The linear polysiloxane according to claim 1, wherein the polysiloxane comprises from 5 to 90 mol % of units having the formula I, from 1 to 10 mol % of units having the formula II, and from 5 to 75 mol % of units having the formula III.

3. The linear polysiloxane according to claims 1 or 2, wherein the polysiloxane further comprises up to 30 mol % of units having a formula selected from at least one of R¹HSiO_{2/2}, R¹₂HSiO_{1/2}, and R¹₂SiO_{2/2}, wherein R¹ is C₁ to C₁₀ hydrocarbyl free of aliphatic unsaturation.

4. A linear polysiloxane comprising from 1 to 99 mol % of units having the formula I, from 1 to 99 mol % of units having the formula III, and units having the formula V: 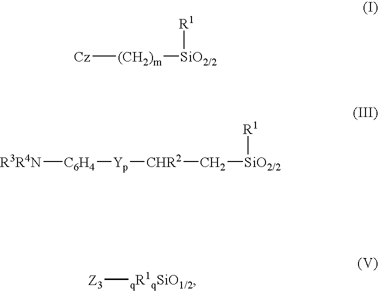
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; Cz is N-carbazolyl; Y is a divalent organic group; Z is a hydrolysable group; m is an integer from 2 to 10; p is 0 or 1; and q is 0, 1, or 2.

5. The linear polysiloxane according to claim 4, wherein the polysiloxane comprises from 5 to 90 mol % of units having the formula I and from 5 to 75 mol % of units having the formula III.

6. The linear polysiloxane according to claims 4 or 5, wherein the polysiloxane further comprises up to 30 mol % of units having a formula selected from at least one of R¹HSiO_{2/2}, R¹₂HSiO_{1/2}, and R¹₂SiO_{2/2}, wherein R¹ is C₁ to C₁₀ hydrocarbyl free of aliphatic unsaturation.

7. A linear polysiloxane comprising from 1 to 99 mol % of units having the formula I, from 1 to 99 mol % of units having the formula III, and units having the formula VI: 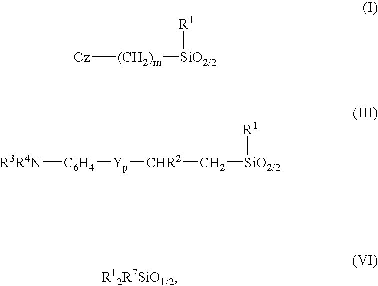
wherein R¹ is C₁ to C₁₀ hydrocarbyl free of aliphatic unsaturation; R² is R¹ or —H; R³ and R⁴ are aryl or together with the nitrogen atom to which they are attached are 10(9H)-acridinyl or 10,11-dihydro-5H-dibenz[b,f]azepin-5-yl; Cz is N-carbazolyl; each R⁷ is independently R¹, —H, —(CH₂)ₘ-Cz, or —CH₂—CHR²—Yₚ—C₆H₄—NPh₂, Cz is N-carbazolyl; Y is a divalent organic group; m is an integer from 2 to 10; and p is 0 or 1.

8. The linear polysiloxane according to claim 7, wherein the polysiloxane contains from 5 to 90 mol % of units having the formula I and from 5 to 75 mol % of units having the formula III.

9. The linear polysiloxane according to claims 7 or 8, wherein the polysiloxane further comprises up to 30 mol % of units having a formula selected from at least one of R¹HSiO_{2/2}, R¹₂HSiO_{2/2}, and R¹₂SiO_{2/2}, wherein R¹ is C₁ to C₁₀ hydrocarbyl free of aliphatic unsaturation.

10. an organic light-emitting diode comprising:
a substrate having a first opposing surface and a second opposing surface;
a first electrode layer overlying the first opposing surface;
a light-emitting element overlying the first electrode layer, the light emitting element comprising
a hole-transport layer and
an emissive/electron-transport layer, wherein the hole-transport layer and the emissive/electron transport layer lie directly on one another, and the hole-transport layer comprises the linear polysiloxane according to claim 7; and
a second electrode layer overlying the light-emitting element.

11. A silicone composition, comprising:
(A) a polysiloxane selected from (i) at least one linear polysiloxane comprising from 1 to 99 mol % of units having the formula I, from 1 to 20 mol % of units having the formula II, 1 to 99 mol % of units having formula III, and units having the formula IV: 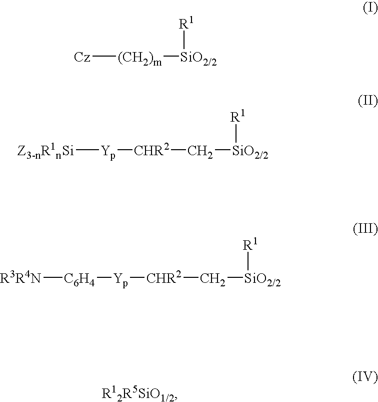
(ii) at least one linear polysiloxane comprising from 1 to 99 mol % of units having the formula I, from 1 to 99 mol % of units having the formula III, and units having the formula V: 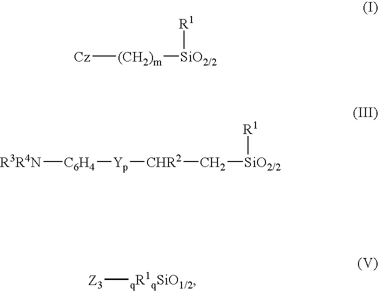
and (iii) a mixture comprising (i) and (ii), wherein R¹ is C₁ to C₁₀ hydrocarbyl free of aliphatic unsaturation; R² is R¹ or —H, R³ and R⁴ are aryl or together with the nitrogen atom to which they are attached are 10(9H)-acridinyl or 10,11-dihydro-5H-dibenz[b,f]azepin-5-yl, each R⁵ is independently R¹, —H, —(CH₂)ₘ-Cz, —CH₂—CHR²—Yₚ—SiR¹ₙZ₃₋ₙ, or —CH₂—CHR²—Yₚ—C₆H₄—NR⁴R³, Cz is N-carbazolyl, Y is a divalent organic group, Z is a hydrolysable group, m is an integer from 2 to 10, n is 0, 1, or 2, and p is 0 or 1, and q is 0, 1, or 2;
(B) a condensation catalyst; and
(C) an organic solvent.

12. An organic light-emitting diode comprising:
a substrate having a first opposing surface and a second opposing surface;
a first electrode layer overlying the first opposing surface;
a light-emitting element overlying the first electrode layer, the light emitting element comprising
a hole-transport layer and
an emissive/electron-transport layer, wherein the hole-transport layer and the emissive/electron transport layer lie directly on one another, and the hole-transport layer comprises a cured polysiloxane prepared by applying the silicone composition according to claim 11 to form a film and curing the film; and
a second electrode layer overlying the light-emitting element.
